(19) United States
(12) Patent Application Publication
(10) Pub. No.: US 2014/0171531 A1
(43) Pub. Date: Jun. 19, 2014

(54) ANTIMICROBIAL BIO POLYURETHANE FOAM AND METHOD FOR MANUFACTURING THE SAME

(71) Applicants: HYUNDAI DYMOS INCORPORATED, Seonsan (KR); HYUNDAI MOTOR COMPANY, Seoul (KR)

(72) Inventors: Seok-Hwan Kim, Gunpo (KR); Jeong Seok Oh, Yongin (KR); Jun-Ho Song, Seoul (KR); Hyung-Won Jeon, Daegu (KR)

(73) Assignees: HYUNDAI DYMOS INCORPORATED, Seonsan (KR); HYUNDAI MOTOR COMPANY, Seoul (KR)

(21) Appl. No.: 14/107,575

(22) Filed: Dec. 16, 2013

(30) Foreign Application Priority Data
Dec. 17, 2012 (KR) 10-2012-0147421
Jul. 2, 2013 (KR) 10-2013-0077329

(51) Int. Cl. A01N 47/20

(52) U.S. Cl. CPC A01N 47/20
USPC 521/137

(57) ABSTRACT

Disclosed is an antimicrobial bio polyurethane foam and a method for manufacturing thereof, and more specifically, a polyurethane foam which comprises a reaction product of a resin premix comprising the biopolyol in an amount of 5 to 30 wt % based on total weight of the resin premix, and a prepolymer. The antimicrobial bio polyurethane foam is enhanced in an antimicrobial property by maximizing the content of the biopolyol.

### CROSS-REFERENCE TO RELATED APPLICATION

The present application claims priority to Korean Patent Application No. 10-2012-0147421 filed on Dec. 17, 2012 and Korean Patent Application No. 10-2013-0077329 filed on Jul. 2, 2013, the entire contents of which are incorporated herein for all purposes by this reference.

### BACKGROUND

(a) Technical Field

The present invention relates to a polyurethane foam, and more specifically, to a polyurethane foam, which is suitable for application to a car seat and the like, and which is enhanced in an antimicrobial property by maximizing the content of a biopolyol component, and a method for manufacturing thereof.

(b) Background Art

Due to the continuous increase of International crude oil prices, petrochemical industries that depend upon petroleum resources are undergoing a crisis. Further, regulations on greenhouse gas emissions are continually being strengthened due to global warming caused by consumption of petroleum resources. Thus, active studies are underway for lowering the degree of dependence upon petroleum resources, including, for example, biotechnology studies.

Herein, the biotechnology studies refer to a technology using biomass, which is repeatedly produced by photosynthesis of plants in the natural world, as a raw material. Such technology is in contrast with the previous chemical industry-based technologies which depending upon fossil materials, such as petroleum resources. For example, biotechnology includes a new bio-chemistry fused-type technology, which can provide sustainable growth and survival of the human race by replacing a portion or many portions of the previous chemical industries.

When comparing the greenhouse gas emissions of the products using the petrochemical materials and bio materials in terms of environmental pollution, the petrochemical material-based products go through processes of petrochemical purification, transfer of the purified material, production of products, transfer of the produced products, and then discarding of the products. Through these processes, a significant amount of greenhouse gas is emitted during the processes of petrochemical purification, and the production and the discarding of the products.

The bio material-based products go through processes of plant growth, transfer of the plant-based raw materials, reduction of greenhouse gas, transfer, and biodegradation and discard of the products. In these processes, the greenhouse gas is absorbed during the production of the raw materials, and is reduced during the production and the discarding of the products compared with the petrochemical materials. Accordingly, the bio material-related technologies are of growing importance in terms of providing an effective response to a carbon tax scheme according to carbon dioxide reduction, improvement of products' competitiveness and the prime cost increase of the petroleum resources.

This bio material-based technologies are continuing to make progress in the midst of a paradigm shift of the 21^{st} century-type chemical industries, which are seeking more eco-friendly and sustainable growth, and particularly in light of trends of the chemical industries towards the development and production of bio-plastics using the biomass as a raw material. Such trends address the needs of cost reduction and protection of the environment.

Particularly, various kinds of vegetable oil-based biopolyols are being developed in a variety of countries based on the available raw materials. In particular, various kinds of biopolyols, for example soybean oil-based polyols in United States, palm oil-based polyols in Malaysia, castor oil and sunflower oil-based polyols in Europe, have been developed and are being marketed.

However, the polyols applied to polyurethane foam for a car seat and the like are required to have higher molecular weight than that provided by most of the vegetable oil-based biopolyols, which generally have lower molecular weight than the conventional polyol. Accordingly, when the vegetable oil-based biopolyols are applied to the polyurethane foam for a car seat and the like, there is a problem of breakdown of the foam or deterioration of physical properties due to unreacted materials contained in the biopolyols.

Further, when conducting a chemical process to remove the unreacted materials contained in the biopolyols, there were problems in that the production cost was increased by the addition of the chemical process, and the advantage of reduction of greenhouse gas emissions by using the bio materials was eliminated by addition of the chemical process.

The description provided above as a related art of the present invention is just for helping understanding the background of the present invention and should not be construed as being included in the related art known by those skilled in the art.

### SUMMARY OF THE DISCLOSURE

The present invention provides antimicrobial bio polyurethane foam, which is more eco-friendly and is enhanced in antimicrobial effect, particularly by maximizing the content of biopolyol. The antimicrobial bio polyurethane foam further demonstrates a comparable level of shape and physical properties as polyurethane foam manufactured by a polymerization reaction using a conventional petroleum-based polyol. The present method further provides a method for manufacturing the antimicrobial bio polyurethane foam.

According to one aspect, the present invention provides an antimicrobial bio polyurethane foam comprising a reaction product of a resin premix and prepolymer. According to a preferred embodiment, the resin premix comprises a biopolyol in an amount of 5 to 30 wt % based on total weight of the resin premix.

According to various embodiments, the prepolymer is formed by prepolymerization of isocyanate and a biopolyol.

According to an exemplary embodiment of the present invention, the amount of the prepolymer is about 30 to 70 parts by weight based on 100 parts by weight of the resin premix.

According to various embodiments, the biopolyol are manufactured from castor oil or soybean oil.

According to an exemplary embodiment of the present invention, the isocyanate is methylene diphenyldiisocyanate (MDI).

According to various embodiments, in consideration of reaction efficiency and the like, it is preferred that the wt % of the biopolyol included in the resin premix based on weight of the resin premix and the wt % of the biopolyol prepolymerized with isocyanate based on weight of the prepolymer are same.

According to various embodiments, the resin premix further comprises one or more of a base polyol, a high molecular polyol and a polymer polyol. According to a preferred embodiment, the resin premix further comprises a base polyol in an amount of about 5 to 40 wt %, high molecular polyol in an amount of about 15 to 55 wt % and polymer polyol in an amount of about 3 to 40 wt %.

With respect to molecular weight, it is preferred that molecular weight (MW) of the biopolyol is about 2500 to 3500, molecular weight (MW) of the base polyol is about 5000 to 6000, and molecular weight (MW) of the high molecular polyol is about 6500 to 7500. These polyols can be selected from any conventional base polyols and high molecular polyols. According to various embodiments, it is preferred that the base polyol and the high molecular polyol are each selected from polyether polyol, polyester polyol or a combination thereof.

According to various embodiments, it is preferred that the resin premix further comprises one or more of a chain extender, a cross-linker, and a silicone surfactant. According to a preferred embodiment, the resin premix further comprises a chain extender in an amount of about 0.1 to 1 wt %, a cross-linker in an amount of more than 0 to less than about 5 wt %, and a silicone surfactant in an amount of about 0.1 to 3 wt %.

Further, in an exemplary embodiment of the present invention, the silicone surfactant comprises a first silicone surfactant and a second silicone surfactant, the second silicone surfactant having relatively stronger activity than the first silicone surfactant.

According to various embodiments, it is preferred that the resin premix having the said composition further comprises one or more of a blowing agent, gelling catalyst, and a blowing catalyst. According to a preferred embodiment, the resin premix further comprises a blowing agent in an amount of about 1 to 5 wt %, a gelling catalyst in an amount of about 0.1 to 3 wt %, and a blowing catalyst in an amount of about 0.1 to 3 wt %.

The said antimicrobial bio polyurethane foam can be applied to manufacture of a car seat.

According to a further aspect, the present invention further comprises a method for manufacturing an antimicrobial bio polyurethane foam comprising: a step of forming a prepolymer by prepolymerizing a biopolyol with isocyanate; and a step of manufacturing the polyurethane foam by reacting the prepolymer and a resin premix comprising a biopolyol in an amount of 5 to 30 wt % based on total weight of the resin premix. According to a preferred embodiment, the isocyanate is methylene diphenyldiisocyanate (MDI).

Further, in consideration of reaction efficiency and the like, it is preferred that the wt % of the biopolyol included in the resin premix based on weight of the resin premix and the wt % of the biopolyol prepolymerized with isocyanate based on weight of the prepolymer) are same.

Other features and aspects of the present invention will be apparent from the following detailed description, drawings and claims.

### BRIEF DESCRIPTION OF THE DRAWINGS

The above and other features of the present invention will now be described in detail with reference to certain exemplary embodiments thereof illustrated the accompanying drawings which are given herein below by way of illustration only, and thus are not limitative of the present invention, and wherein: FIG. 1 is a picture showing a conventional biopolyol-based polyurethane foam comprising biopolyol of 10 wt % based on weight of a resin premix;

FIG. 2 is a picture showing a conventional biopolyol-based polyurethane foam comprising biopolyol of 20 wt % based on weight of a resin premix;

FIG. 3 is a picture showing a conventional biopolyol-based polyurethane foam comprising biopolyol of 30 wt % based on weight of a resin premix;

FIG. 4 is a schematic diagram of manufacturing the conventional bio polyurethane foam;

FIG. 5 is a schematic diagram of manufacturing bio polyurethane foam by prepolymerization according to an embodiment of the present invention; and

FIG. 6 is a schematic diagram of showing a specific process for forming a prepolymer according to an embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The terms and the words used in the specification and claims should not be construed with common or dictionary meanings, but construed as meanings and conception coinciding the spirit of the invention based on a principle that the inventors can appropriately define the concept of the terms to explain the invention in the optimum method. Therefore, embodiments described in the specification and the configurations shown in the drawings are not more than the most preferred embodiments of the present invention and do not fully cover the spirit of the present invention. Accordingly, it should be understood that there may be various equivalents and modifications that can replace those when this application is filed.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, present invention now will be described in detail with reference to the accompanying drawings.

In one point of view, the present invention relates to a bio polyurethane foam which is more eco-friendly and is enhanced in an antimicrobial function. In particular, the present invention relates to such a bio polyurethane foam that is provided with such advantages by maximizing the content of one or more biopolyol.

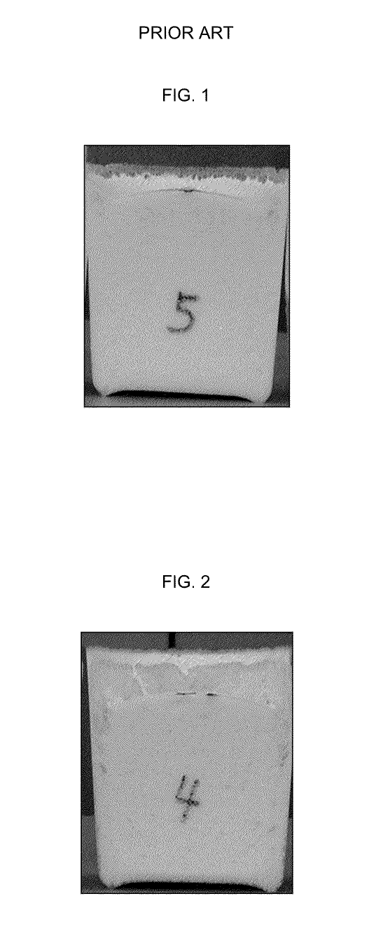

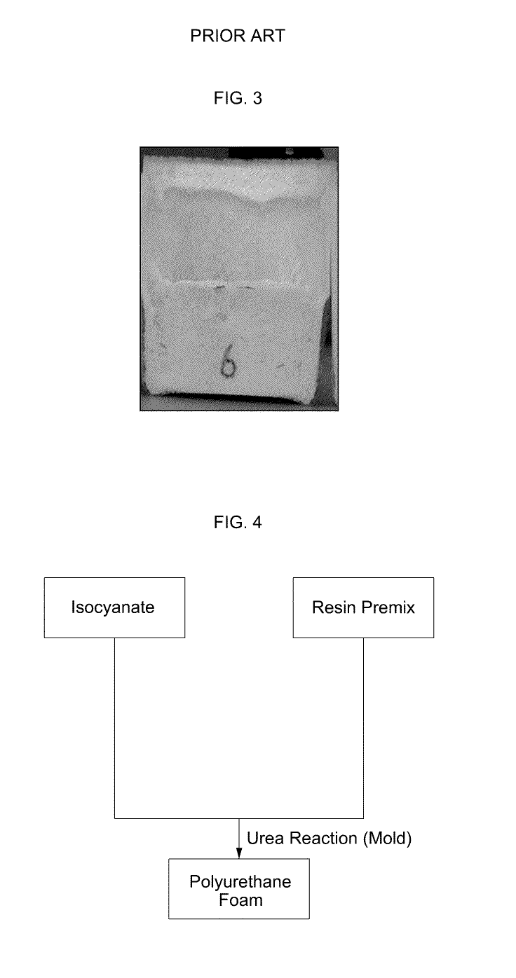

FIG. 1 to FIG. 3 are pictures showing conventional biopolyol-based polyurethane foams comprising the biopolyol in an amount of 10 wt %, 20 wt % and 30 wt % based on weight of the resin premix, respectively. As shown therein, in the case of the conventional bio polyurethane foam, as the amount of the biopolyol increases, unreacted material contained in the biopolyol also increases. As a result, breakdown of the foam and reduction of physical properties become more severe.

As one example, a castor oil-based biopolyol comprises ricinoleic acid as a major ingredient, and further comprises stearic acid, linoleic acid, oleic acid and the like. The ingredients other than the ricinoleic acid exist as unreacted materials and thereby prevent formation of a normal foam, thus biopolyol based on soybean oil also due to unreacted materials results in breakdown of the foam and reduction of physical properties become more severe.

To solve this problem, the present invention provides an antimicrobial bio polyurethane foam having enhanced antimicrobial properties by the unreacted materials. The present invention further provides an antimicrobial bio polyurethane foam having the same level of shape and physical properties as the conventional petroleum polyol-based polyurethane foam by comprising a reaction product of a resin premix, which comprises a biopolyol in a large (e.g. maximum) amount, one or more further polyols, various additives and the like, and prepolymer.

Specifically, the present invention relates to a polyurethane foam comprising the reaction product of a resin premix and a prepolymer. Preferably, the resin premix comprises a first biopolyol in an amount of about 5 to 30 wt % based on the total weight of the resin premix.

According to various embodiments, the prepolymer is formed by prepolymerization of isocyanate and the biopolyol.

Preferably, the amount of the prepolymer is about 30 to 70 parts by weight, more preferably about 50 parts by weight, based on 100 parts by weight of the resin premix. When the amount is less than about 30 parts by weight, cell stability of the foam may be deteriorated. On the other hand, when the amount exceeds about 70 parts by weight, the formed foam may be easily broken due to overproduction of the foam cells. Accordingly, it is preferred to satisfy the said range.

According to various embodiments, the isocyanate is selected from methylene diphenyldiisocyanate (MDI) or toluenediisocyanate (TDI) and the like. Preferably, the isocyanate is methylene diphenyldiisocyanate (MDI), which is an aromatic diisocyanate. MDI is largely classified into MDI monomers and polymeric MDIs, and the MDI monomers comprise an isomer, such as 2,2′-MDI, 2,4′-MDI and 4,4′-MDI.

(A) Biopolyol

The biopolyol means a polyol manufactured by using vegetable oil extracted from seeds or fruits of various plants, animal oil from various kinds of fish-based oils, and the like. Such polyols are unlike polyether polyol and polyester polyol, which are manufactured from a raw petrochemical material. According to various embodiments, a molecular weight (MW) of the biopolymer is preferably about 2500 to 3500.

According to various embodiments, the biopolyol is manufactured from vegetable oil by any conventional method. Preferably, a the vegetable oil is at least one selected from the group consisting of castor oil, soybean oil, palm oil, canola oil and sunflower oil. According to an exemplary embodiment, the vegetable oil of castor oil or soybean oil is preferable.

According to various embodiments, the biopolyol is preferably contained in an amount of about 5 to 30 wt % based on weight of the resin premix. When the amount is less than about 5 wt %, the effect obtained by adding the biopolyol, i.e., reduction of greenhouse gas emissions and the antimicrobial effect, may be insufficient. On the other hand, when the amount exceeds about 30 wt %, the foam may be hardly formed, and physical properties may be deteriorated. According to a further preferred embodiment, the first biopolyol is added in an amount of greater than 20 wt % and up to about 30 wt % based on weight of the resin premix. Accordingly, it is preferred to satisfy the said range.

Further, in order to secure reaction stability and to improve reaction efficiency, it is preferred that the wt % of the biopolyol (based on weight of the resin premix) and the wt % of the biopolyol (based on weight of the prepolymer) are similar to the wt % of the biopolyol polymerized with isocyanate, and preferably are the same. According to a preferred embodiment, the total wt % of the total biopolyols in the foam is greater than 20 wt %, based on total weight of the foam composition.

According to various embodiments, it is preferred that the resin premix further comprises one or more of a base polyol, a high molecular polyol, and a polymer polyol. In particular, it is preferred that the resin premix further comprises a base polyol in an amount of 5 about to 40 wt %, the high molecular polyol in an amount of about 15 to 55 wt % and the polymer polyol in an amount of about 3 to 40 wt %.

(B) Base Polyol

The base polyol means the conventional petroleum-based polyol and commonly known polyols, which are applied to polyurethane foams, such as polyether polyol, polyester polyol or a combination thereof. According to preferred embodiments, the base polyol has a molecular weight (MW) of about 5000 to 6000.

It is preferred to contain this base polyol in an amount of about 5 to 40 wt % based on weight of the resin premix. When the amount is less than about 5 wt %, there may be a problem of increase of vibration transmissibility rate. On the other hand, when the amount exceeds about 40 wt %, compression permanent decrease rate may be deteriorated. Accordingly, it is preferred to satisfy the said range.

(C) High Molecular Polyol

The high molecular polyol means commonly known polyols, which are applied to polyurethane foams, such as polyether polyols, polyester polyols or a combination thereof like the base polyol. In order to improve resilience and elongation rate of the formed foam, it is preferred that the high molecular polyol has a molecular weight (MW) larger than the base polyol, preferably a MW of about 6500 to 7500.

It is preferred to contain this high molecular polyol in an amount of about 15 to 55 wt % based on weight of the resin premix. When the amount is less than about 15 wt %, the resilience may be significantly reduced. On the other hand, when the amount exceeds about 55 wt %, the resilience may increase, thereby deteriorating the comfort required for soft polyurethane foam. Accordingly, it is preferred to satisfy the said range.

(D) Polymer Polyol

The polymer polyol is also referred to as a copolymer polyol, and is used for improving hardness and the like by mixing in with the base polyol.

It is preferred to contain the polymer polyol in an amount of about 3 to 40 wt % based on weight of the resin premix. When the amount is less than about 3 wt %, the hardness may be significantly decreased, and the potential applications for the polyurethane foam may decrease. On the other hand, when the amount exceeds about 40 wt %, the hardness may increase, thereby deteriorating the comfort required for soft polyurethane foam. Accordingly, it is preferred to satisfy the said range.

According to various embodiments, it is preferred that the resin premix further comprise one or more of a chain extender, a cross-linker, and a silicone surfactant. In particular, it is preferred that the resin premix further comprise a chain extender in an amount of about 0.1 to 1 wt %, a cross-linker in an amount of more than 0 to less than about 5 wt %, a silicone surfactant in an amount of about 0.1 to 3 wt %.

(E) Chain Extender and Cross-Linker

The chain extender and the cross-linker are reactive monomers used for enhancing intermolecular bonding. The chain extender plays a role of extending a main chain, and it may be selected from any conventional chain extenders, particularly bivalent alcohols or amines. The cross-linker plays a role of making the chains form a mesh structure or branched structure in order to prevent the breakdown of the foam and to improve tensile strength, dry set and the like. The cross-linker may be selected from any conventional cross-linkers, particularly trivalent alcohols or amines.

In one embodiment of the present invention, the chain extender is 1,4-butane diol (OH—V=500˜1500 mg KOH/g), and the cross-linker is triethanolamine.

Further, it is preferred to contain the chain extender in an amount of about 0.1 to 1 wt % based on weight of the resin premix. When the amount is less than about 0.1 wt %, the effect of extending the main chain may be meager. On the other hand, when the amount exceeds about 1 wt %, fluidity may be deteriorated. Accordingly, it is preferred to satisfy the said range.

Further, it is preferred to contain the cross-linker in an amount of more than 0 to less than about 5 wt % based on weight of the resin premix. When the amount exceeds to about 5 wt %, the fluidity may be deteriorated, thereby potentially increasing the defect rate. Accordingly, it is preferred to satisfy the said range.

(F) Silicone Surfactant

The silicone surfactant plays roles of facilitating mixing of raw materials (emulsification), helping bubble growth by lowering surface tension of a urethane system, and preventing gas diffusion by lowering pressure difference between bubbles. According to preferred embodiments, the first silicone surfactant and the second silicone surfactant are provided as set forth below.

TABLE 1

| | First Silicone | Second Silicone |
|---|---|---|
| | Surfactant | Surfactant |
| Silicone Polymer MW | Low | High |
| Branched Polyether | Low | High |
| Branched Polyethylene | High | Low |
| Ethyleneoxide (PE EO) | | |

The Table 1 is a table comparing the first silicone surfactant and the second silicone surfactant used in the present invention. The first silicone surfactant can be a silicone surfactant used in polyurethane foam manufactured from the conventional petroleum-based polyol. The second silicone surfactant is a material optionally added together with the first silicone surfactant, and has an effect of effectively preventing breakdown of the foam caused by addition of the biopolyol. In particular, when the second silicone surfactant has stronger activity than the first silicone surfactant, it is capable of effectively preventing breakdown of the foam.

It is preferred to contain the silicone surfactant, comprising the first silicone surfactant and the second silicone surfactant, in an amount of about 0.1 to 3 wt % based on weight of the resin premix. When the amount is less than about 0.1 wt %, the urethane foam may be hardly formed. On the other hand, when the amount exceeds about 3 wt %, the productivity may be deteriorated by overproduction of closed cells. Accordingly, it is preferred to satisfy the said range.

It is preferred that the resin premix further comprises one or more of a blowing agent, a gelling catalyst, and a blowing catalyst. According to a preferred embodiment, the resin premix further comprises a blowing agent in an amount of about 1 to 5 wt %, a gelling catalyst in an amount of about 0.1 to 3 wt % and a blowing catalyst in an amount of about 0.1 to 2 wt %. Any conventional blowing agents, gelling catalysts, a blowing catalysts may suitably be used.

(G) Blowing Agent

The blowing agent is a material used for manufacturing foam and plays a role of forming bubbles during polymer reaction.

It is preferred to contain the blowing agent in an amount of about 1 to 5 wt % based on weight of the resin premix. When the amount is less than about 1 wt %, blowing rate may be lowered, thereby formation of the foam may be difficult. On the other hand, when the amount exceeds about 5 wt %, physical properties may be deteriorated by over blowing. Accordingly, it is preferred to satisfy the said range.

(H) Gelling Catalyst and Blowing Catalyst

The gelling catalyst is a catalyst that accelerates the reaction of the polyol and the isocyanate, and it may be selected from conventional gelling catalysts such as organic metals (tin compound, lead compound and the like), a part of tertiary amines (TEDA) and the like. The blowing catalyst is a catalyst that accelerates saturation reaction of the isocyanate and water, and it may be selected from conventional blowing catalysts such as a part of tertiary amines (PMDETA, BDMEE) and the like.

It is preferred that the gelling catalyst is added in an amount of about 0.1 to 3 wt % based on weight of the resin premix. When the amount is less than about 0.1 wt %, productivity may be deteriorated by lowered curing property. On the other hand, when the amount exceeds about 3 wt %, the fluidity may be deteriorated, thereby porosity may be poor. Accordingly, it is preferred to satisfy the said range.

It is preferred that the blowing catalyst is added in an amount of about 0.1 to 2 wt % based on weight of the resin premix, and the reasons for limiting the upper limit and the lower limit are same as the gelling catalyst.

The polyurethane foam having the said composition is eco-friendly, expresses excellent antimicrobial property, and further demonstrates the same level of physical properties as the conventional petroleum-based polyol. Accordingly, it can be applied to manufacture of a cushion or a car seat and the like.

According to a further aspect, the present invention relates to a method for manufacturing the bio polyurethane foam, which is more eco-friendly and is enhanced in an antimicrobial function, particularly by maximizing the content of a biopolyol by introducing prepolymerization.

FIG. 4 is a schematic diagram of a manufacturing process of the conventional bio polyurethane foam. As shown therein, the polyurethane foam can be manufactured by a urea reaction of the resin premix comprising a biopolyol and the like and an isocyanate.

However, when using common polymerization, the biopolyol can be contained in an amount of up to 20 wt % based on weight of the resin premix. When the amount exceeds 20 wt %, unreacted materials contained in the biopolyol lead to breakdown of the foam and deterioration of physical properties. Accordingly, as mentioned above, the biopolyol cannot be contained in an amount in excess of 20 wt % based on weight of the resin premix when using common polymerization.

The present invention maximizes the content of abiopolyol by introducing prepolymerization, which is a new raw material blending technology.

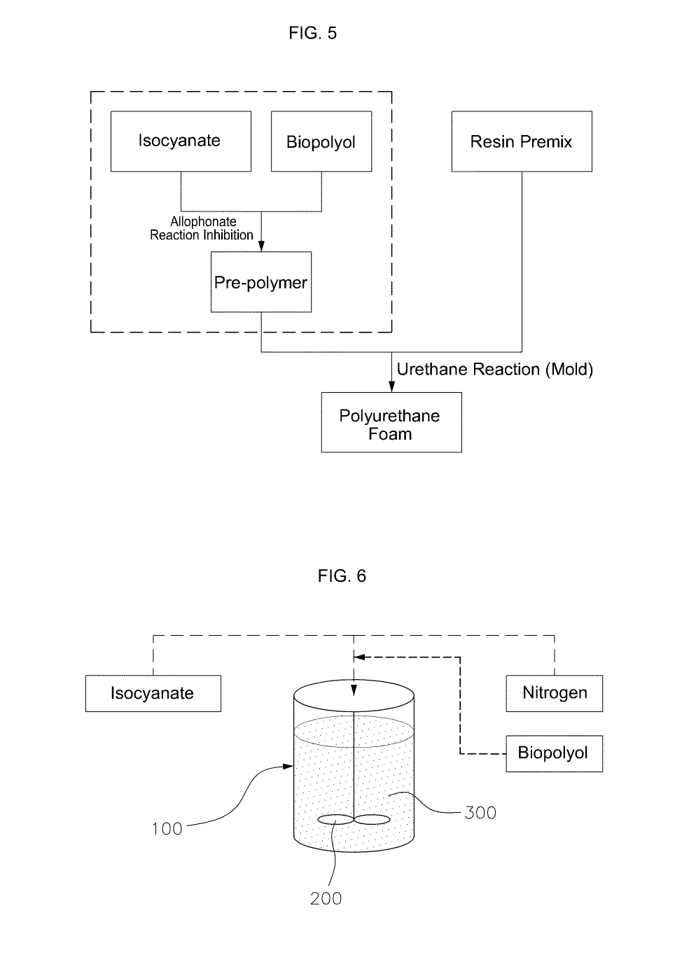

FIG. 5 is a schematic diagram of a method for manufacturing the bio polyurethane foam by prepolymerization according to an embodiment of the present invention. As shown therein, the prepolymer is formed by prepolymerizing of the biopolyol, particularly, the second biopolyol and the isocyanate.

FIG. 6 is a schematic diagram showing a specific process for forming the prepolymer according to an embodiment of the present invention. In this method, it is preferred to prevent moisture influx into a reactor 100 by using nitrogen pressure, and to form the prepolymer 300 by slowly adding the biopolyol and stirring with an agitator 200. This has the effect of not inducing an allophonate reaction because the allophonate reaction is induced when the biopolyol is rapidly added to the reactor 100 containing the isocyanate.

Thereafter, the polyurethane foam according to the present invention can be manufactured by reacting the prepolymer and the resin premix comprising the first biopolyol in an amount of about 5 to 30 wt % based on total weight of the resin premix. (Urea reaction)

At this time, the specific compositions, conditions and the like of the resin premix and the prepolymer are the same as mentioned above.

Through this prepolymerization, the biopolyol in the resin premix is contained in an amount of about 5 to 30 wt % based on weight of the resin premix, preferably wherein the amount is greater than 20 wt %. Accordingly, the content of the biopolyol can be maximized, and the same level of physical properties as the conventional petroleum-based polyol can be attained without breakdown of the foam, and, further, enhanced antimicrobial property can be expressed.

### Example 1

Hereinafter, the present invention will be described in further detail with reference to examples. It will be obvious to a person having ordinary skill in the art that these examples are illustrative purposes only and are not to be construed to limit the scope of the present invention.

TABLE 2

| | Comparative | Example 1 | Example 2 |
|---|---|---|---|
| | Example 1 (wt %) | (wt %) | (wt %) |
| Base Polyol | 66.66 | 9.29 | 9.29 |
| Bio Polyol | — | 27.89 | 29.89 |
| High Molecular Polyol | — | 27.88 | 27.88 |
| Polymer Polyol | 28.57 | 27.88 | 26.39 |
| Blowing Catalyst | 0.29 | 0.28 | 0.28 |
| Gelling Catalyst | 0.67 | 0.65 | 0.65 |
| Cross-linker | — | 0.74 | 0.54 |
| Chain Extender | — | 1.58 | 1.18 |
| First Silicone Surfactant | 0.95 | 0.74 | 0.74 |
| Second Silicone Surfactant | — | 0.28 | 0.28 |
| Blowing Agent | 2.86 | 2.79 | 2.88 |

The above Table 2 is a table comparing the resin premix compositions of the polyurethane foam manufactured from the conventional petroleum-based polyol (Comparative Example 1) and the polyurethane foam manufactured from the biopolyol based on castor oil (Example 1) and the polyurethane foam manufactured from the biopolyol based on soybean oil (Example 2) according to an embodiment of the present invention. In the case of the present invention, polyurethane foam was manufactured by reacting the prepolymer of 50 parts by weight based on 100 parts by weight of the resin premix having the said compositions according to a common known method and the results are shown in Table 3,

TABLE 3

| | Comparative | | |
|---|---|---|---|
| | Example 1 | Example 1 | Example 2 |
| Hardness (ILD) | 26.2 | 25.8 | 26.5 |
| Resilience | 65 | 64 | 60 |
| Tensile | 1.7 | 1.7 | 1.6 |
| Elongation Rate | 120 | 121 | 119 |
| Dry Heat. Compression | 10 | 10 | 12 |
| Permanent Deformation | | | |
| (Dry set, 80° C., 75% m 22 | | | |
| hr) | | | |

As shown in Table 3, it could be found that, although the polyurethane foam according to the present invention contained the biopolyol in an amount of up to 30 wt % based on the weight of the resin premix, it showed the same level of shape and physical properties as the polyurethane foam manufactured from the conventional petroleum-based polyol.

In addition, the antimicrobial effect of the polyurethane foam according to the present invention was enhanced by the unreacted materials (except the ricinoleic acid) in the biopolyol. Accordingly, it was observed in further detail as follows.

TABLE 4

| | | | Compara- | | |
|---|---|---|---|---|---|
| | | | tive | | |
| Section | | Blank | Example 1 | Example 1 | Example 2 |
| Staphy- | Initial | 2.0 × 10\hat{ }4 | 2.0 × 10\hat{ }4 | 2.0 × 10\hat{ }4 | 3.0 × 10\hat{ }4 |
| lococcus | Bacteria | | | | |
| aureus | Number/ml | | | | |
| | 18 hrs | 2.2 × 10\hat{ }6 | 1.3 × 10\hat{ }6 | 8.5 × 10\hat{ }4 | 2.9 × 10\hat{ }3 |
| | later/ml | | | | |
| | Bacteria | — | 40.9% | 96.1% | 99.9% |
| | Ruction Rate | | | | |
| Kleb- | Initial | 2.5 × 10\hat{ }4 | 2.5 × 10\hat{ }4 | 2.5 × 10\hat{ }4 | 2.0 × 10\hat{ }4 |
| siella | Bacteria | | | | |
| pneu- | Number/ml | | | | |
| moniae | 18 hrs | 1.6 × 10\hat{ }6 | 8.5 × 10\hat{ }6 | 5.0 × 10\hat{ }4 | <10 |
| | later/ml | | | | |
| | Bacteria | — | 46.9% | 68.8% | 99.9% |
| | Ruction Rate | | | | |

The above Table 4 is a table comparing the antimicrobial effect of the polyurethane foam manufactured from the conventional petroleum-based polyol (Comparative Example 1) and the polyurethane foam manufactured from the biopolyol based on castor oil (Example 1) and the polyurethane foam manufactured from the biopolyol based on soybean oil (Example 2) according to an embodiment of the present invention, and is the result of measuring the number of bacteria after injecting solutions containing Staphylococcus aureus (ATCC 6538) and Klebsiella pneumonia (ATCC 4352) in an amount of 0.2 cc, respectively, to a sample followed by maintaining at 37° C. for 18 hours.

(Test Institute: FITI testing and research institute, Test Standard: KS K 0693-2006 antibacterial activity)

As shown in the above table, it was confirmed that the polyurethane foam according to the present invention showed significantly improved antimicrobial effect as compared with the conventional polyurethane foam. In particular, this was caused by the unreacted materials in the biopolyol. It was further found that the physical properties of the foam were maintained even though the unreacted materials were in the biopolyol, and that the antimicrobial function was enhanced by the unreacted materials.

The polyurethane foam according to the present invention having the constitution described above demonstrates the same level of shape and physical properties as the conventional polyurethane foam manufactured from the petroleum-based polyol, particularly by improving the defects of the conventional polyol-based biopolyol polyurethane foams.

Further, the present invention has an advantage of showing excellent antimicrobial properties such as reducing Staphylococcus aureusor Kiebsiella pneumonia by the unreacted materials contained in the biopolyol.

In addition, the present invention maximizes the content of the biopolyol by introducing prepolymerization, and accordingly, eco-friendly products, which can significantly reduce greenhouse gas emissions, are produced.

The invention has been described in detail with reference to preferred embodiments thereof. However, it will be appreciated by those skilled in the art that changes or modifications may be made in these embodiments without departing from the principles and spirit of the invention, the scope of which is defined in the appended claims and their equivalents.

What is claimed is:

1. Antimicrobial bio polyurethane foam comprising a reaction product of a resin premix and prepolymer, wherein the resin premix comprises the biopolyol in an amount of about 5 to 30 wt %.

2. The antimicrobial bio polyurethane foam according to claim 1, wherein the prepolymer is formed by prepolymerization of isocyanate and the biopolyol.

3. The antimicrobial bio polyurethane foam according to claim 2, wherein the amount of the prepolymer is about 30 to 70 parts by weight based on 100 parts by weight of the resin premix.

4. The antimicrobial bio polyurethane foam according to claim 2, wherein the first biopolyol and the second biopolyol are manufactured from castor oil or soybean oil.

5. The antimicrobial bio polyurethane foam according to claim 2, wherein the isocyanate is methylene diphenyldiisocyanate (MDI).

6. The antimicrobial bio polyurethane foam according to claim 2, wherein the isocyanate is methylene diphenyldiisocyanate (MDI).

7. The antimicrobial bio polyurethane foam according to claim 2, wherein the wt % of the first biopolyol based on weight of the resin premix and the wt % of the second biopolyol based on weight of the prepolymer are same.

8. The antimicrobial bio polyurethane foam according to claim 1, wherein the resin premix further comprises at least one base polyol in an amount of about 5 to 40 wt %, at least one high molecular polyol in an amount of about 15 to 55 wt % and at least one polymer polyol in an amount of about 3 to 40 wt %.

9. The antimicrobial bio polyurethane foam according to claim 8, wherein a molecular weight (MW) of the biopolyol is about 2500 to 3500, a molecular weight (MW) of the base polyol is about 5000 to 6000, and a molecular weight (MW) of the high molecular polyol is about 6500 to 7500.

10. The antimicrobial bio polyurethane foam according to claim 8, wherein the base polyol and the high molecular polyol are selected from the group consisting of polyether polyol, polyester polyol and a combination thereof.

11. The antimicrobial bio polyurethane foam according to claim 8, wherein the resin premix further comprises at least one chain extender in an amount of about 0.1 to 1 wt %, at least one cross-linker in an amount of more than 0 to less than about 5 wt %, and at least one silicone surfactant in an amount of about 0.1 to 3 wt %.

12. The antimicrobial bio polyurethane foam according to claim 11, wherein the silicone surfactant comprises a first silicone surfactant and a second silicone surfactant, the second silicone surfactant having relatively stronger activity than the first silicone surfactant.

13. The antimicrobial bio polyurethane foam according to claim 11, wherein the resin premix further comprises at least one blowing agent in an amount of about 1 to 5 wt %, at least one gelling catalyst in an amount of about 0.1 to 3 wt %, and at least one blowing catalyst in an amount of about 0.1 to 3 wt %.

14. A car seat manufactured from the antimicrobial bio polyurethane foam according to claim 1.

15. A method for manufacturing an antimicrobial bio polyurethane foam comprising:
a step of forming prepolymer by prepolymerizing the biopolyol with isocyanate; and
a step of manufacturing the polyurethane foam by reacting the prepolymer and a resin premix comprising the biopolyol in an amount of about 5 to 30 wt % based on total weight of the resin premix.

16. The method for manufacturing antimicrobial bio polyurethane foam according to claim 15, wherein the isocyanate is methylene diphenyldiisocyanate (MDI).

17. The method for manufacturing antimicrobial bio polyurethane foam according to claim 15, wherein a wt % of the biopolyol based on weight of the resin premix and a wt % of the biopolyol prepolymerized with isocyanate based on weight of the prepolymer are the same.
